(19) United States
(12) Patent Application Publication
(10) Pub. No.: US 2025/0042694 A1
(43) Pub. Date: Feb. 6, 2025

(54) ELEVATOR SYSTEM AND METHOD FOR OPERATING AN ELEVATOR SYSTEM

(71) Applicant: Inventio AG, Hergiswil (CH)

(72) Inventor: Romeo Lo Jacono, Gravesano (CH)

(21) Appl. No.: 18/723,492

(22) PCT Filed: Dec. 12, 2022
(86) PCT No.: PCT/EP2022/085282

§ 371 Date: Jun. 24, 2024

(30) Foreign Application Priority Data
Dec. 30, 2021 (EP) 21218265.3
May 31, 2022 (EP) 22176475.6

(51) Int. Cl. B66B 5/28; B66B 11/02; B66B 19/00

(52) U.S. Cl. CPC B66B 5/282; B66B 5/284; B66B 11/0266; B66B 19/00

(57) ABSTRACT

An elevator system includes an elevator car on which are mounted buffers that are each assigned to and connected to a support means. The buffers are adapted for damping the elevator car during travel of the car.

### FIELD

The invention relates to an elevator system. The elevator system for conveying persons or goods has an elevator car that can be moved up and down in an elevator shaft between floors.

### BACKGROUND

Buffers are used to temporarily support the elevator car against the shaft pit in the event of a buffer run. Such buffers are important parts of safety equipment in elevator systems and have the task of stopping the elevator car not abruptly but within a short braking distance in the event of any unbraked travel (so-called buffer travel) into the shaft pit due to malfunctions, while providing the best possible protection for passengers and protecting the material. Buffers are often located in the shaft pit of an elevator system. In elevator systems with shaft pits with shallow pit depths, or for pitless elevators, buffers can be attached to the car, as is known for example from WO 2017/064123 A1.

### SUMMARY

It is an object of the present invention to avoid the disadvantages of the known elevator system and in particular to create an improved elevator system. In particular, the elevator system should be able to be installed in buildings with shaft pits with shallow pit depths. The elevator car of the elevator system should be characterized by a small space requirement and compact design, while at the same time offering good travel comfort.

These and other objects are achieved according to the invention with the elevator system that is described herein. The elevator system comprises an elevator car to which at least one buffer associated with a support means is attached, wherein the buffer is connected to a support means for supporting the elevator car. The buffer is used to temporarily support the elevator car against the shaft floor during any buffer travel. Because the buffer is connected to a support means for carrying the elevator car, the buffer can be used for damping the elevator car during car travel. Vibrations coming from the support means or the drive can be damped by means of the buffer.

The elevator system is characterized by its simple design. Another advantage is that it is space-saving. The elevator system is low in cost and yet effective in terms of safety and ride comfort.

The elevator system can comprise an elevator car that can preferably be moved vertically up and down and is supported by one or more support means, wherein the support means for suspending the elevator car at the car floor is guided at a suspension point, which suspension point is positioned on the floor of the elevator car. However, the elevator system can also have a dual design with regard to the suspension, which results in an advantageous weight balance. In this case, the elevator system may comprise an elevator car supported by support means, the support means for suspending the elevator car at the floor side being guided at suspension points arranged on opposite sides of the elevator car, which points are positioned on the floor of the elevator car. The elevator system therefore has two buffers, with each buffer being connected to a support means.

In other words, the buffer, which contacts the shaft floor to support the elevator car during any buffer travel, serves to cushion the elevator car when it touches down on the shaft floor. The buffer can be positioned below a suspension point. The buffer is preferably arranged in the vertical projection of the suspension point, the support means and the buffer assigned to it being particularly preferably coaxial to each other.

The connection of the at least one buffer to the support means can generally result in the buffer or buffers being located outside the vertical projection of the elevator car with respect to its car body for accommodating the passengers and/or goods. It is conceivable to provide additional car-side buffers that are arranged within the vertical projection of the elevator car. These additional buffers would be of conventional design and not connected to the support means.

A damping element formed by the buffer can be provided in a suspension point to dampen the vibrations generated by the drive and transmitted to the car by the support means.

In a further embodiment, the respective buffer can have a preferably hollow-cylindrical buffer body through which the support means or a support means connecting piece connected to the support means is guided. The buffer body can have a corresponding cavity for the guiding through of the support means or support means connecting piece.

The buffer body can thus form the aforementioned damping element. Instead of a hollow cylinder, other shapes for the buffer body are also conceivable. For example, the buffer could also have a conical outer contour. Thanks to the buffer body, vibrations coming from the drive or the support means can be effectively damped. Buffer bodies of this type can be procured easily and inexpensively and adapted to suit requirements.

The buffer body can be made of an elastomer. The buffer body can be made of rubber.

An end part can be fixed to the free end of the support means, which end part directly or indirectly abuts the buffer body. The end part can be for example a threaded nut which is screwed onto a support means connecting piece comprising a threaded rod and which is preferably secured using appropriate securing means.

In terms of operational safety and durability, it can be advantageous if the buffer has an impact element. The impact element can preferably be made of a metallic material, for example steel. The impact element is a component of the buffer via which the pressure forces to be dampened by the buffer can be introduced into the buffer body when it touches down. The impact element protects the buffer body from wear.

The impact element can for example be made from a metal plate using a forming process.

The support means can be attached to the impact element. The vibrations of the support means are transmitted to the buffer body via the impact plate. The end part can rest on the impact element and be supported by it.

The impact element can have a central indentation complementary to the hollow space of the buffer body for the form-fit reception of the impact element in the interior of the hollow cylinder, so that the impact element can be inserted into the buffer body via this.

The support means can be one or more belts. Support belts have the advantage that space can be optimally utilized thanks to the belts, and they are particularly suitable for space-saving designs. Of course, the support means could be formed by one or more cables.

A further aspect of the invention relates to an elevator car for the elevator system described above. At least one buffer associated with a support means for supporting or suspending the elevator car is attached to the elevator car for temporarily supporting the elevator car relative to the shaft floor during any buffer travel (or for cushioning the elevator car when it touches down on the shaft floor), which buffer can be connected or is connected to the support means. Alternatively formulated, the elevator car according to the invention can have at least one buffer on which or over which the elevator car can be suspended. In other words, the buffers define the suspension points and are therefore an integral part of the suspension points. The buffers have a dual function. On the one hand, they cushion the elevator car downwards when it touches down on the shaft floor, as do conventional buffers; on the other hand, they are now also used to support or suspend the elevator car.

In procedural terms, the invention relates to a method for operating an elevator system and in particular the elevator system described above, wherein at least one buffer is provided on the elevator car for temporarily supporting the elevator car relative to the shaft floor during any buffer travel, wherein the at least one buffer, in addition to the supporting function, is also used for damping the elevator car as it moves up and down in order to increase travel comfort. This elevator car is particularly suitable for elevator systems with shaft pits with shallow pit depths, or for pitless elevators.

### DESCRIPTION OF THE DRAWINGS

Further individual features and advantages of the invention are derived from the following description of an embodiment and from the drawings. In the drawings:

FIG. 1 shows a simplified side view of an elevator system according to the invention,

FIG. 2 shows an enlarged sectional view at the bottom of the elevator car shown in FIG. 1, and

FIG. 3 shows an enlarged illustration of a suspension point (detail A from FIG. 2).

### DETAILED DESCRIPTION

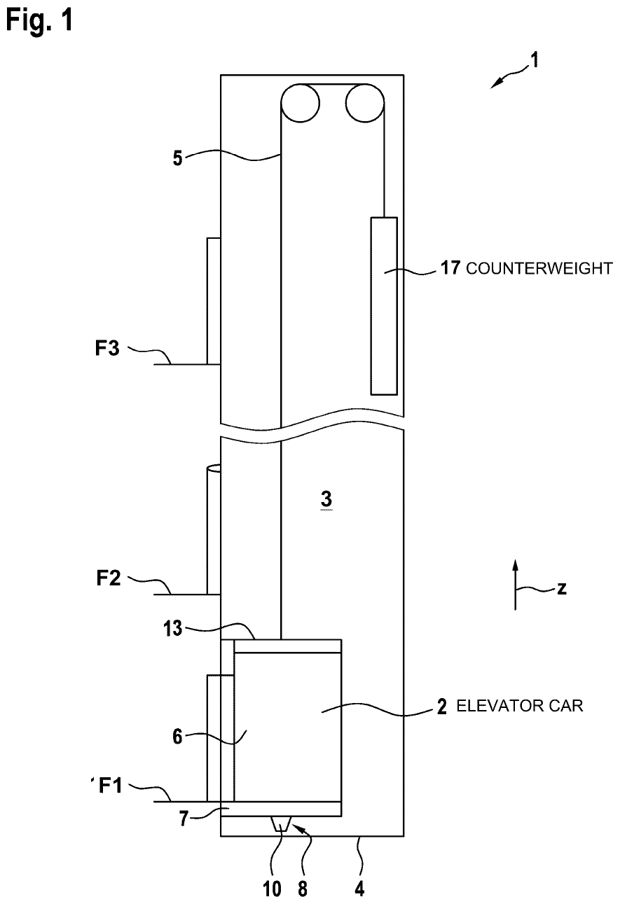

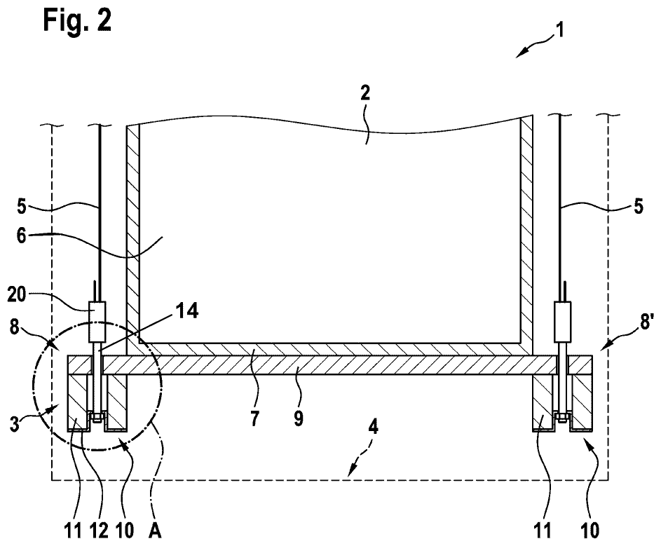

FIG. 1 shows an elevator system, designated as a whole by 1, for a multi-story building. The building has an elevator shaft 3 connecting with floors F1, F2 and F3. The elevator system 1 contains an elevator car, marked 2, which can be moved vertically up and down in the elevator shaft 3 for transporting people or goods to individual floors F1-F3. The elevator car 2 has side walls 6, a car roof 13 and a car floor 7, which form a generally rectangular car body. The car body is mounted on a support structure 9 (see FIG. 2), which is associated with the car floor 7.

The elevator car 2 is moved via support means, denoted with reference sign 5, on which the car 2 is suspended; in this case, the support means 5 can be one or more support belts. However, suspension cables are also conceivable as support means 5. The support means 5 are connected to a drive (not shown) for moving the car 2.

For structural or other reasons, there may not be enough space for a conventional elevator system with a shaft pit 4 and shaft head. Such special elevator systems are known and commonly used with such low shaft pits having pit depths that are less than 60 cm and preferably less than 35 cm. The elevator system 1 shown here and explained in detail below is particularly suitable for such elevator systems with shaft pits with shallow pit depths, or for pitless elevators.

The elevator system 1 can also comprise at least one counterweight 17 connected by the support means 5 to the car 2, which can be moved up and down in the opposite direction to the car 2. The elevator car 2 and the at least one counterweight 17 are moved along vertical guides (not shown). As a rule, such elevator systems have only one drive, for example a traction sheave drive, which is used to drive the support means and thus move the elevator car and the counterweight in opposite directions.

However, the elevator system 1 can also have two counterweights. Each of the support means 5 is connected to one of the two counterweights 17. The elevator system 1 can have special guide rails with which both the elevator car 2 and the respective counterweights 17 serve as linear guides. The guide rails can be manufactured as one-piece rolled profiles. Such an elevator system 1 can be designed as a so-called “front bag elevator”. Further details on the front bag elevator and the guidance of the elevator car 2 and the counterweights 17 with common guide rails can be found in WO 2020/127303 A1 and WO 2020/127787 A1.

The support means 5 for suspending the elevator car 2 at the floor side are guided at suspension points 8, 8′ (see FIG. 2) arranged on opposite sides of the elevator car 2, which, as can be seen, are positioned on the car floor 7 of the elevator car 2 at the support structure 9. The suspension points 8, 8′ and thus also the buffers 10 are located outside the vertical projection of the elevator car 2 in relation to its car body, which is defined by the car side walls 6.

Buffers 10, each assigned to a support means 5, are attached to the elevator car 2 for the temporary supporting of the elevator car 2 against the shaft floor during any buffer travel. Each buffer 10 is connected to one of the support means 5. The elevator car 2 is thus suspended on or above the buffers 10, whereby a damping of the elevator car 2 during car travel is achieved thanks to the buffers 10. The vibrations generated by the drive and transmitted to the car 2 by the support means 5 can thus be easily reduced, resulting in good travel comfort. In addition to good damping behavior, this design is also characterized by easy installation.

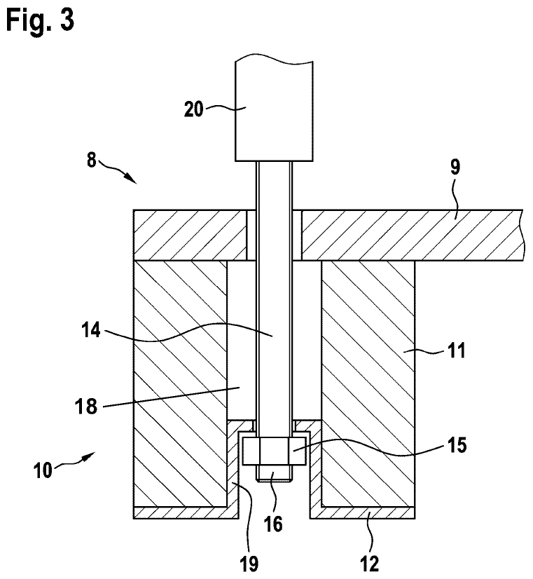

Construction details of the special design of the suspension point 8 for supporting or suspending the elevator car 2 can be seen in FIG. 3 that enlarges detail A of FIG. 2. The suspension point 8 is defined by the buffer 10, which has a hollow cylindrical buffer body 11. The buffer body 11 can be designed as a one-piece molded body and be made of rubber or a plastics material, in particular an elastomer. The support means 5 or, more precisely, a support means connecting piece 14 connected to the support means 5, is guided through the buffer body 11. The buffer body 11 is preferably rotationally symmetrical.

The support means 5 is fitted with a support means end connection 20 at the end of the car, to which a support means connecting piece 14 is connected. The support means end connection 20 can be a support means end connection as known for example from WO 03/022723 A1 or EP 2 261 162 A1. The support means connecting piece 14 has a threaded rod. An end part 15 formed by a nut is located at the free end of the support means connecting piece 14. As shown in FIG. 3, a securing device 16 is provided to secure the end part 15.

The buffer 10 also comprises an impact element 12, preferably made of a metallic material. During buffer travel, the impact element 12 contacts the shaft floor (or possibly a metallic counterpiece attached to the shaft floor to form a stop). The support means 5 is attached to the impact element 12. The end part 15 rests on the impact element 12 and is supported by it. During car travel, the vibrations or oscillations of the support means 5 are transmitted to the buffer body 11 via the impact element 12.

The impact element 12 has a central indentation 19 complementary to the hollow space 18 of the hollow cylinder body 11 for the form-fit receiving of the impact element 12 in the hollow space, so that the impact element 12 can be inserted into the buffer body 11 via this.

In addition to the impact element 12, the buffer 10 can have a sleeve-like housing (not shown) for receiving the buffer body 11.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11 (canceled)

12. An elevator system including an elevator car movable in an elevator shaft, a support means being attached to the elevator car at a suspension point arranged at the elevator car, the elevator system comprising:
a buffer attached to the elevator car and adapted to temporarily support the elevator car relative to a shaft floor of the elevator shaft during any buffer travel;
the buffer being connected to the support means at the suspension point; and
the buffer including a body configured as a damping element damping vibrations transmitted to the elevator car by the support means.

13. The elevator system according to claim 12 wherein the buffer body has a hollow-cylindrical form with a hollow space, and the support means, or a support means connecting piece connected to the support means, is guided through the hollow space of the buffer body.

14. The elevator system according to claim 12 including an end part fixed to a free end of the support means, the end part directly or indirectly abutting the buffer body.

15. The elevator system according to claim 12 wherein the buffer includes an impact element adapted to contact the shaft floor.

16. The elevator system according to claim 15 wherein the impact element is made of a metallic material.

17. The elevator system according to claim 15 wherein the support means is fastened to the impact element.

18. The elevator system according to claim 15 wherein the impact element has a central indentation complementary to a hollow space in the buffer body.

19. The elevator system according to claim 12 wherein the support means includes belts.

20. An elevator car for an elevator system, the elevator system including a support means for supporting the elevator car in an elevator shaft of the elevator system, the elevator car comprising:
a suspension point arranged at the elevator car and adapted to attach the support means to the elevator car;
a buffer attached to the elevator car and adapted to temporarily support the elevator car relative to a shaft floor of the elevator shaft during any buffer travel, wherein the buffer is adapted to connect to the support means at the suspension point; and
the buffer including a body configured as a damping element damping vibrations transmitted to the elevator car by the support means when the buffer is connected to the support means.

21. The elevator car according to claim 20 wherein the buffer body has a hollow-cylindrical form with a hollow space, and a support means connecting piece, connected to the support means is guided through the hollow space of the buffer body.

22. A method for operating an elevator system, the elevator system including an elevator car movable in an elevator shaft and being attached to a support means at a suspension point, the method comprising the steps of:
attaching a buffer to the elevator car in a position to contact and temporarily support the elevator car relative to a shaft floor of the elevator shaft during any buffer travel;
connecting the buffer to the support means at the suspension point; and
providing the buffer with a body configured as a damping element damping vibrations transmitted to the elevator car by the support means.
